(19) United States
(12) Patent Application Publication
(10) Pub. No.: US 2008/0062509 A1
(43) Pub. Date: Mar. 13, 2008

(54) DIFFRACTIVE OPTICAL ELEMENT, EXPOSURE APPARATUS AND DEVICE MANUFACTURING METHOD

(75) Inventor: Takanori Uemura, Utsunomiya-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/849,770

(22) Filed: Sep. 4, 2007

(30) Foreign Application Priority Data
Sep. 7, 2006 (JP) 2006-243392
Aug. 23, 2007 (JP) 2007-217244

(51) Int. Cl. G02B 3/00; G02B 5/18; G02B 5/30

(52) U.S. Cl. 359/362; 359/485; 359/566

(57) ABSTRACT

A diffractive optical element is disclosed. The diffractive optical element is used in an illumination optical system of an exposure apparatus which exposes a substrate, and used for forming the intensity distribution of light at a pupil plane of the illumination optical system. The diffractive optical element comprises a first diffractive element and a second diffractive element which have different diffraction actions from each other, wherein each of the first diffractive element and the second diffractive element has point symmetry in a irradiated region where light is irradiated and common center of the point symmetry.

### BACKGROUND OF THE INVENTION

1. Field of the Invention

The present invention relates to an exposure apparatus and a device manufacturing method.

2. Description of the Related Art

In recent years, along with further progress in an increase in semiconductor processing speed and the miniaturization of electronic devices, a demand for micropatterning semiconductor devices is becoming stronger. Photolithography is therefore an indispensable technique of forming a fine circuit pattern on a substrate (irradiation target surface) such as a silicon wafer or glass plate.

To form a fine circuit pattern, it is necessary to reduce a resolution R of an exposure apparatus in photolithography. The resolution R of the exposure apparatus is expressed by a so-called Rayleigh equation:

R=k1×λ/(NA) (1)

### Equation (1) reveals that to reduce the resolution R, it suffices to decrease the process coefficient k1 or light source wavelength λ or increase the numerical aperture NA of a projection optical system.

Decreasing the light source wavelength λ of an exposure light source often leads to a high cost and an increase in the absorbance or birefringence of a glass material. This may lower the exposure efficiency and therefore make it impossible to obtain a desired imaging performance.

Increasing the NA of the projection optical system using an immersion exposure technique often makes the projection optical system large in size and complicated in structure. This may increase the manufacturing cost of the exposure apparatus.

Use of a resolution enhancement technology (to be referred to as an RET hereinafter) makes it possible to decrease the process coefficient k1 without changing the light source wavelength λ or the NA of the projection optical system.

One example of the RET is a method of providing an auxiliary pattern or an offset of the line width with a reticle in accordance with the optical characteristics of an exposure optical system.

Another example of the RET is an off axis illumination method of forming off axis illumination by changing the shape of an effective light source of an illumination optical system in accordance with the reticle pattern.

There is available a off axis illumination method of arranging a stop having an annular zonal, dipolar, or quadrupolar shape near the pupil conjugate plane (the pupil plane of the illumination optical system) of the projection optical system. This method may lower the apparatus throughput because the amount of light which reaches the irradiation target surface decreases as the stop partially shields it.

There is available another off axis illumination method of inserting a conical or pyramidal prism in the illumination optical system. This method is gradually becoming impractical to form a desired effective light source as device manufacture requires more complicated and diversified off axis illumination.

There is available still another off axis illumination method using a diffractive optical element in place of a stop or prism. For example, as the diffractive optical element, a computer generated hologram (to be referred to as a CGH hereinafter) designed using a computer to image a desired diffraction pattern on a diffraction pattern surface can be used. This method can form an effective light source having a complicated shape.

Merely inserting the diffractive optical element in the illumination optical system is sometimes insufficient to obtain a degree of freedom high enough to adjust an effective light source distribution. For example, dipole illumination or quadrupole illumination sometimes requires a large number of diffractive optical elements to individually adjust the amounts of light of the respective poles. Accordingly, the degree of freedom is insufficient to adjust the effective light source distribution.

To cope with this problem, U.S. Pat. No. 6,833,907B2 discloses a technique of forming one diffractive optical element by combining a plurality of diffractive elements having different diffraction actions. In this diffractive optical element, one or more diffractive elements of the plurality of diffractive elements can be moved in a direction perpendicular to the optical axis direction to change the intensity ratio of light beams which enter the respective diffractive elements. This makes it possible to adjust the relative intensities of diffraction patterns obtained by the respective diffractive elements to ensure a degree of freedom high enough to adjust the effective light source distribution.

Japanese Patent Laid-Open No. 2006-5319 also discloses a technique of forming one diffractive optical element by combining a plurality of diffractive elements having different diffraction actions. In this diffractive optical element, the center of a light irradiated region is shifted from its center of gravity to change the intensity ratio of light beams which enter the respective diffractive elements. This makes it possible to adjust the relative intensities of diffraction patterns obtained by the respective diffractive elements to ensure a degree of freedom high enough to adjust the effective light source distribution.

Unfortunately, the technique disclosed in U.S. Pat. No. 6,833,907B2 suffers a poor symmetry of the diffractive element with respect to the optical axis because the plurality of diffractive elements move relative to the optical axis. The technique disclosed in Japanese Patent Laid-Open No. 2006-5319 also suffers a poor symmetry of the diffractive element with respect to the optical axis because the center of each element shifts from the optical axis.

In this way, a poor symmetry of the illumination optical system with respect to the optical axis shifts secondary light sources formed by a so-called optical integrator such as a fly-eye lens or pipe that is indispensable to uniformly illuminate the irradiation target surface. With this phenomenon, the telecentricity of a light beam with respect to the irradiation target surface tends to break. Consequently, the imaging performance may suffer.

In addition, when a prism is arranged on the rear side of the diffractive optical device, a poor symmetry of the diffractive optical element with respect to the optical axis make light beams passing through the prism asymmetrical with respect to the optical axis. Since this deforms the effective light source distribution, the telecentricity of a light beam with respect to the irradiation target surface breaks to result in a decrease in CD (Critical Dimension) uniformity. Consequently, the imaging performance may suffer.

### SUMMARY OF THE INVENTION

It is an object of the present invention to provide an exposure apparatus capable of minimizing deterioration in imaging performance and a device manufacturing method.

According to the first aspect of the present invention, there is provided a diffractive optical element used in an illumination optical system of an exposure apparatus which exposes a substrate, and used for forming the intensity distribution of light at a pupil plane of the illumination optical system, the diffractive optical element comprising: a first diffractive element and a second diffractive element which have different diffraction actions from each other, wherein each of the first diffractive element and the second diffractive element has point symmetry in a irradiated region where light is irradiated and common center of the point symmetry.

According to the second aspect of the present invention, there is provided an exposure apparatus which illuminates a mask by a illumination optical system exposes a substrate by projecting a pattern of the mask onto the substrate via a projection optical system, the exposure apparatus comprising: a diffractive optical element including a first diffractive element and a second diffractive element which have different diffraction actions from each other, the diffractive optical element forming the intensity distribution of light at a pupil plane of the illumination optical system, wherein each of the first diffractive element and the second diffractive element has point symmetry in a irradiated region where light is irradiated and common center of the point symmetry.

According to the third aspect of the present invention, there is provided a device manufacturing method comprising the steps of forming a latent pattern on a substrate using the above-described exposure apparatus, and developing the latent pattern.

According to the present invention, it is possible to minimize deterioration in imaging performance.

Further features of the present invention will become apparent from the following description of exemplary embodiments with reference to the attached drawings.

### BRIEF DESCRIPTION OF THE DRAWINGS

FIG. 1 shows the arrangement of an exposure apparatus according to the first embodiment;

FIG. 2 shows refraction of a prism unit;

FIG. 3 shows the reason why secondary sources shift in a multi-beam generating unit;

FIG. 4 shows the arrangement of a diffractive optical element according to the first embodiment;

FIG. 5 shows diffraction patterns formed on a diffraction pattern surface;

FIG. 6 shows an effect of zooming by a zoom lens unit;

FIG. 7 shows another effect of zooming by the zoom lens unit;

FIG. 8 shows still another effect of zooming by the zoom lens unit;

FIG. 9 shows still another effect of zooming by the zoom lens unit;

FIG. 10 shows still another effect of zooming by the zoom lens unit;

FIG. 11 shows still another effect of zooming by the zoom lens unit;

FIG. 12 shows an optical system from the diffractive optical element to the diffraction pattern surface;

FIG. 13 shows the arrangement of an exposure apparatus according to the second embodiment;

FIG. 14 shows the arrangement of a diffractive optical element according to the second embodiment;

FIG. 15 shows diffraction patterns formed on a diffraction pattern surface;

FIG. 16 shows an effect of zooming by a zoom lens unit;

FIG. 17 shows another effect of zooming by the zoom lens unit;

FIG. 18 shows still another effect of zooming by the zoom lens unit;

FIG. 19 shows still another effect of zooming by the zoom lens unit;

FIG. 20 shows the arrangement of an exposure apparatus according to the third embodiment;

FIG. 21 shows the arrangement of a diffractive optical element according to the third embodiment;

FIG. 22 shows diffraction patterns formed on a diffraction pattern surface;

FIG. 23 shows an effect of zooming by a zoom lens unit;

FIG. 24 shows another effect of zooming by the zoom lens unit;

FIG. 25 shows still another effect of zooming by the zoom lens unit;

FIG. 26 shows still another effect of zooming by the zoom lens unit;

FIG. 27 shows still another effect of zooming by the zoom lens unit;

FIG. 28 shows still another effect of zooming by the zoom lens unit;

FIG. 29 shows the arrangement of an exposure apparatus according to the fourth embodiment;

FIG. 30 shows the relationship between the optical axis and the polarization direction; and

FIG. 31 is a flowchart illustrating the sequence of the overall semiconductor device manufacturing process.

### DESCRIPTION OF THE EMBODIMENTS

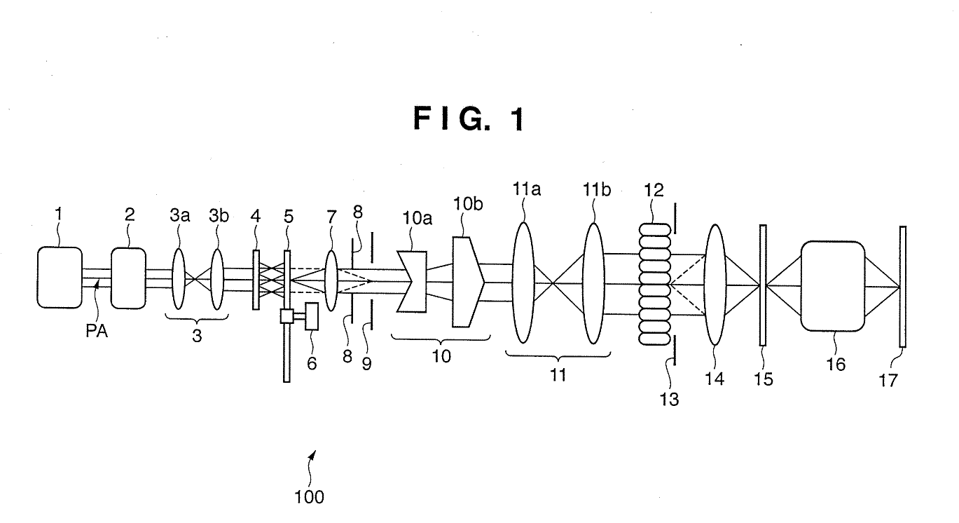

An exposure apparatus according to the first embodiment of the present invention will be described with reference to FIG. 1. FIG. 1 shows the arrangement of the exposure apparatus according to the first embodiment.

The schematic arrangement and schematic operation of an exposure apparatus 100 will be explained first.

The exposure apparatus 100 comprises an illumination optical system and projection optical system.

The illumination optical system supplies light from a light source 1 to the projection optical system. The projection optical system projects the light onto a wafer 17 coated with a resist. This exposes the resist to light to form a latent pattern on it. The latent pattern is then developed to form a desired circuit pattern on the wafer 17.

The illumination optical system comprises a relay optical system 2, zoom lens unit 3, exit angle preserving optical element 4, diffractive optical element 5, actuator 6, condenser lens 7, light-shielding member 8, prism unit 10, zoom lens unit 11, multi-beam generating unit 12, stop 13, and condenser lens 14. The projection optical system comprises a projection optical system 16.

The light source 1, relay optical system 2, zoom lens unit 3, exit angle preserving optical element 4, diffractive optical element 5, condenser lens 7, light-shielding member 8, prism unit 10, zoom lens unit 11, multi-beam generating unit 12, stop 13, condenser lens 14, and projection optical system 16 are arranged such that an optical axis PA serves as their centers.

The light source 1 emits light (a light beam). The light source 1 emits light such as ArF laser light having a wavelength of about 193 nm or KrF laser light having a wavelength of about 248 nm. The light source 1 may emit laser light of another type or wavelength, or may use, for example, a mercury lamp which emits non-laser light.

The relay optical system 2 is interposed between the light source 1 and the zoom lens unit 3. With this arrangement, the relay optical system 2 guides the light beam from the light source 1 to the zoom lens unit 3.

The zoom lens unit 3 is interposed between the relay optical system 2 and the exit angle preserving optical element 4. The zoom lens unit 3 includes first and second lenses 3a and 3b. The zoom lens unit 3 executes zooming by changing the distance between the first and second lenses 3a and 3b. This makes it possible to guide the light beam from the relay optical system 2 to the exit angle preserving optical element 4 to adjust the first irradiated region. The first irradiated region is defined as the region which of the exit angle preserving optical element 4 the light beam enters. Effects of zooming will be described later.

The exit angle preserving optical element 4 is interposed between the zoom lens unit 3 and the diffractive optical element 5. The exit angle preserving optical element 4 includes an optical integrator such as a microlens array or fiber bundle. With this arrangement, the light beam from the zoom lens unit 3 is guided to the diffractive optical element 5 while maintaining its divergence angle constant. This makes it possible to reduce the influence of the output variation of the light source 1 on the diffraction pattern distribution on the diffractive optical element 5 and to reduce the influence of the change of NA by zooming of the zoom lens unit 3.

The diffractive optical element 5 is arranged on the Fourier transform plane of the pupil plane of the illumination optical system to form a predetermined light intensity distribution on the pupil plane of the illumination optical system, that is conjugate to the pupil of the projection optical system or on the plane conjugated to the pupil plane of the illumination optical system. The diffractive optical element 5 is interposed between the exit angle preserving optical element 4 and the condenser lens 7. The diffractive optical element 5 is mounted on a turret having a plurality of slots. With this arrangement, the light beam from the exit angle preserving optical element 4 is applied to the second irradiated region of the diffractive optical element 5, diffracted by the diffractive optical element 5, and guided to the condenser lens 7. The second irradiated region is adjusted upon adjusting the first irradiated region. The second irradiated region is defined as the region which of the diffractive optical element 5 the light beam enters.

The turret connects to the actuator 6 to be pivotable. A diffractive optical element other than the diffractive optical element 5 is also mounted on the turret. As the actuator 6 pivots the turret, a diffractive optical element other than the diffractive optical element 5 can move onto the optical axis PA.

The condenser lens 7 is interposed between the diffractive optical element 5 and a first prism 10a. With this arrangement, the condenser lens 7 condenses the light beam diffracted by the diffractive optical element 5 to form a diffraction pattern on a diffraction pattern surface 9 existing between the condenser lens 7 and the first prism 10a.

Meanwhile, when the actuator 6 exchanges the diffractive optical element inserted on the optical axis PA, it is possible to change the shape of the diffraction pattern formed on the diffraction pattern surface 9.

The light-shielding member 8 is interposed between the condenser lens 7 and the first prism 10a to be defocused from the diffraction pattern surface 9. Examples of the light-shielding member 8 are a stop, blade, or filter. As the light-shielding member 8 is defocused from the diffraction pattern surface 9, it is possible to, when the light-shielding member 8 partially shields the light beam, adjust an effective light source distribution without rapidly changing the light intensity.

Meanwhile, the light-shielding member 8 may be arranged at a position other than that between the diffractive optical element 5 and the diffraction pattern surface 9 as long as it is interposed between the diffractive optical element 5 and the multi-beam generating unit 12.

The prism unit 10 is interposed between the diffraction pattern surface 9 and the zoom lens unit 11. The prism unit 10 includes the first prism 10a and a second prism 10b. The prism unit 10 allows zooming by changing the distance between the first and second prisms 10a and 10b. This makes it possible to guide the light beam in accordance with the diffraction pattern formed on the diffraction pattern surface 9 to the zoom lens unit 11 with its annular ratio and aperture angle adjusted.

The zoom lens unit 11 is interposed between the prism unit 10 and the multi-beam generating unit 12. The zoom lens unit 11 includes third and fourth lenses 11a and 11b. The zoom lens unit 11 executes zooming by changing the distance between the third and fourth lenses 11a and 11b. This makes it possible to guide the light beam in accordance with the diffraction pattern formed on the diffraction pattern surface 9 to the multi-beam generating unit 12 with its σ value adjusted.

The multi-beam generating unit 12 is interposed between the zoom lens unit 11 and the condenser lens 14. This makes it possible to form a large number of secondary light sources in accordance with the diffraction pattern having adjusted annular ratio, adjusted aperture angle, and adjusted σ value, and to guide the secondary light beam to the condenser lens 14. The stop 13 is interposed between the multi-beam generating unit 12 and the condenser lens 14. This makes it possible to adjust the amount of light guided from the multi-beam generating unit 12 to the condenser lens 14.

The condenser lens 14 is interposed between the multi-beam generating unit 12 and a mask 15. This makes it possible to illuminate the mask 15 in a superimposed manner by condensing a large number of the secondary light beams guided from the multi-beam generating unit 12.

Meanwhile, although the multi-beam generating unit 12 is formed by a fly-eye lens, it may be formed by an optical integrator of another form such as a pipe, diffractive optical element or microlens array.

The mask 15 is interposed between the condenser lens 14 and the projection optical system 16. A pattern corresponding to the layout pattern of a circuit is drawn on the mask 15. A large number of the secondary light beams are diffracted by the pattern drawn on the mask 15, and guided to the projection optical system 16.

The projection optical system 16 is interposed between the mask 15 and the wafer 17, and makes them conjugate to each other. With this arrangement, the projection optical system 16 images the pattern drawn on the mask 15 (on the resist) on the wafer 17.

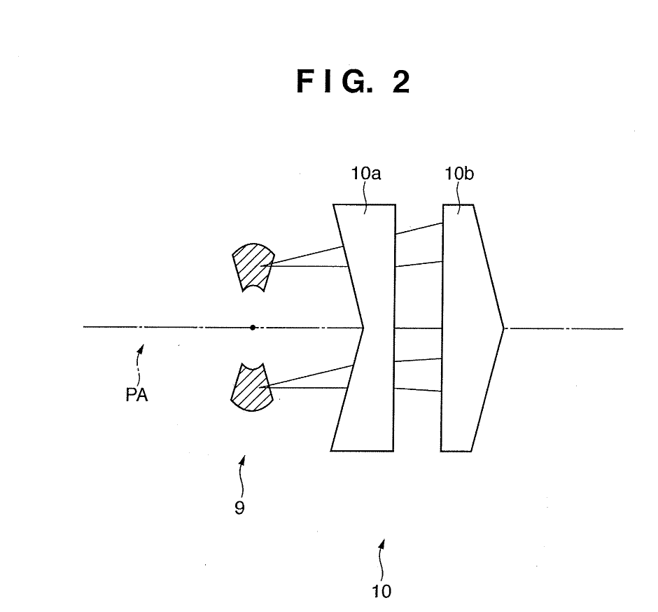

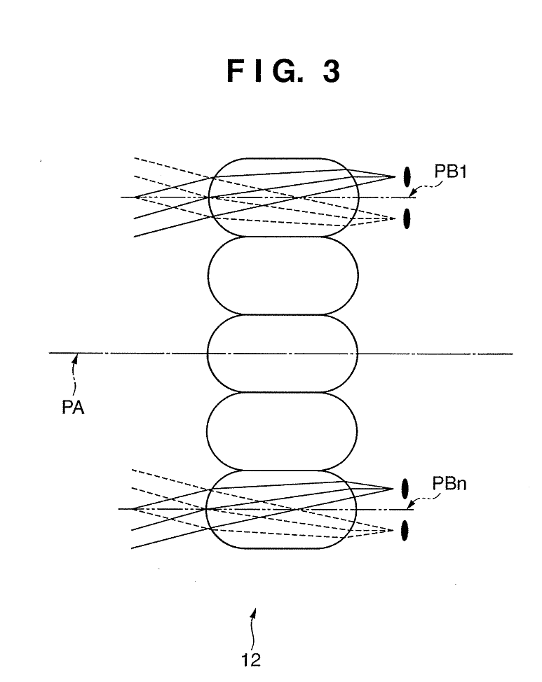

A problem of the present invention will be explained with reference to FIGS. 2 and 3. FIG. 2 shows refraction of a prism unit. FIG. 3 shows the reason why secondary light sources shift in the multi-beam generating unit 12.

A case wherein prisms (the first and second prisms 10a and 10b) are arranged on the rear side of the diffractive optical element will be exemplified. FIG. 2 shows refraction of the prism unit 10 when the symmetry of the diffractive optical element 5 with respect to the optical axis PA is poor. That is, if the symmetry of the diffractive optical element 5 with respect to the optical axis PA is poor, the directions (angular distribution) of the light beams which enter the diffraction pattern surface 9 become asymmetrical with respect to the optical axis PA. With this phenomenon, the light beams which enter the first prism 10a also become asymmetrical with respect to the optical axis PA. The light beams which enter the first prism 10a cause different refraction actions on the upper and lower sides of the optical axis PA in, for example, the Y direction.

This phenomenon will be explained in more detail. FIG. 2 shows the optical paths of light beams which emerge from two positions on the diffraction pattern surface 9, that are symmetrically spaced apart from the optical axis PA. On the incident surface of the multi-beam generating unit 12, the two light beams form a vertical distribution having asymmetry with respect to the optical axis PA. That is, if the two exit light beams form different angles of the center of gravity with respect to the optical axis PA, they receive different refraction actions of the prisms. This forms an asymmetrical distribution on the incident surface of the multi-beam generating unit 12. The first and second prisms 10a and 10b have a conical shape.

Assume that the symmetry of the diffractive optical element 5 with respect to the optical axis PA is poor, and that the multi-beam generating unit 12 is a fly-eye lens. As shown in FIG. 3, each fly eye of the multi-beam generating unit 12 is irradiated with light beams indicated by solid lines or alternatively with light beams indicated by dotted lines. In this way, when the light beams which enter the fly eyes incline departing from a direction parallel to the optical axis PA, the positions of respective secondary light sources that image on the condensing point of the fly eye shift from secondary optical axes PB1 to PBn. The secondary optical axes PB1 to PBn pass through the centers of gravity of the respective fly eyes, and are parallel to the optical axis PA. Since the effective light source distribution deforms, the telecentricity of a light beam with respect to the irradiation target surface breaks to result in a decrease in CD uniformity. Consequently, the imaging performance may suffer.

To cope with this problem, the exposure apparatus according to the first embodiment of the present invention has the following characteristic features.

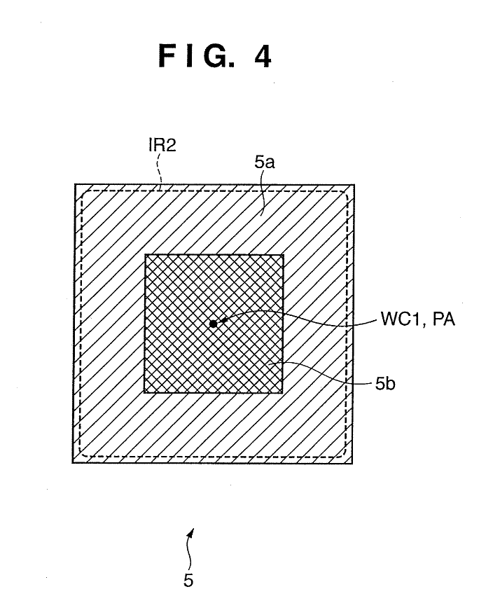

The detailed arrangement of the diffractive optical element will be explained with reference to FIG. 4. FIG. 4 shows the arrangement of the diffractive optical element according to the first embodiment.

The diffractive optical element 5 comprises first and second diffractive elements 5b and 5a.

The first diffractive element 5b is indicated by a cross-hatched portion and formed into an almost square shape having point symmetry (more specifically, 4-fold rotational symmetry) with respect to a diffraction surface center of gravity WC1 of the diffractive optical element 5. A shape having point symmetry means a shape which lands on an image of itself when it is rotated 180 degrees around a point. The diffraction surface center of gravity WC1 is defined as the center of gravity of the surface on which the diffraction action is performed. The first diffractive element 5b has an uneven shape (not shown) for diffraction and the uneven shape does not need to have point symmetry.

The second diffractive element 5a is indicated by a hatched portion and formed into an almost hollow square shape having point symmetry (more specifically, 4-fold rotational symmetry) with respect to the diffraction surface center of gravity WC1 of the diffractive optical element 5. The second diffractive element 5a has an uneven shape (not shown) for diffraction. The second diffractive element 5a has a different uneven shape for diffraction from that of the first diffractive element 5b. This allows the first and second diffractive elements 5b and 5a to have different diffraction actions and the uneven shape does not need to have point symmetry.

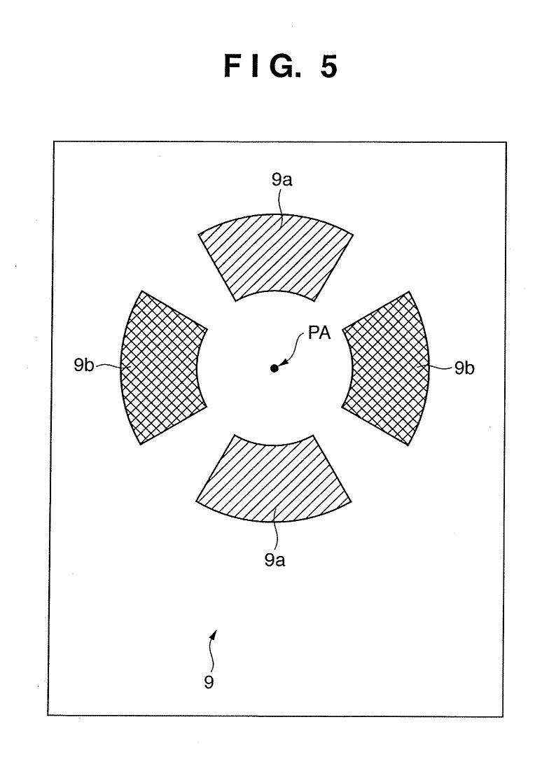

The detailed operation of the diffractive optical element will be explained with reference to FIGS. 4 and 5. FIG. 5 shows diffraction patterns formed on the diffraction pattern surface.

Assume, for example, that a second irradiated region IR2 covers the entire surface of the diffractive optical element 5, that is, the entire surfaces of the first and second diffractive elements 5b and 5a, as shown in FIG. 4. A light beam applied to the first diffractive element 5b is diffracted by its uneven surface and forms dipolar patterns 9b (see FIG. 5) on the diffraction pattern surface 9 in the X direction. A light beam applied to the second diffractive element 5a is diffracted by its uneven surface and forms dipolar patterns 9a (see FIG. 5) on the diffraction pattern surface 9 in the Y direction.

The center (optical axis PA) of the second irradiated region IR2 is almost coincident with the diffraction surface center of gravity WC1 of the diffractive optical element 5. With this arrangement, the directions (angular distribution) of the light beams which enter the diffraction pattern surface 9 become symmetrical about the optical axis PA. This reduces the positional shifts of a center of the respective secondary light sources to the secondary optical axes PB1 to PBn (see FIG. 3) in the multi-beam generating unit 12. Since deformation of an effective light source can be reduced, it is possible to suppress the telecentricity of a light beam with respect to the irradiation target surface from breaking and the CD uniformity from decreasing. This makes it possible to minimize deterioration in imaging performance.

Referring to FIG. 5, portions corresponding to those in FIG. 4 are indicated by the same hatching patterns.

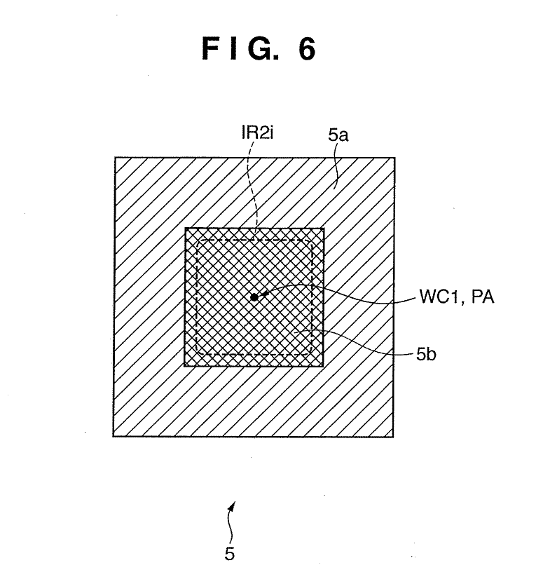

Effects of zooming by the zoom lens unit 3 will be explained with reference to FIGS. 6 to 11.

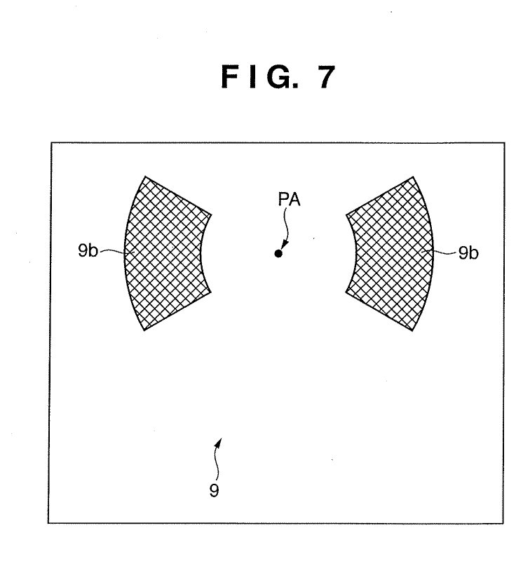

For example, as shown in FIG. 6, the zoom lens unit 3 (see FIG. 1) adjusts a second irradiated region IR2i so that it covers only the first diffractive element 5b. A light beam applied to the first diffractive element 5b is diffracted by its uneven surface and forms dipolar patterns 9b on the diffraction pattern surface 9 in the X direction, as shown in FIG. 7. On the other hand, the second diffractive element 5a receives no light beam and hence forms no dipolar patterns 9a on the diffraction pattern surface 9 in the Y direction.

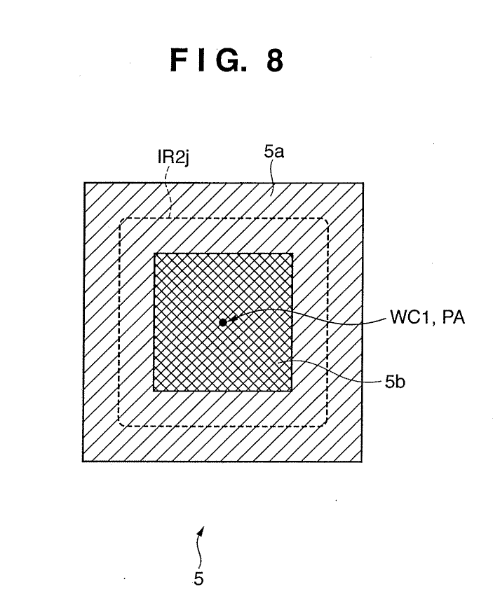

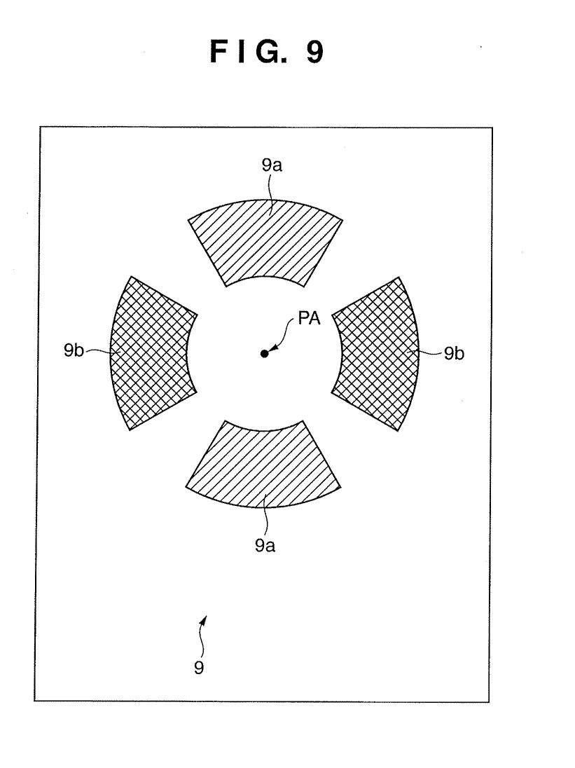

For example, as shown in FIG. 8, the zoom lens unit 3 (see FIG. 1) adjusts a second irradiated region IR2j so that it covers the entire surface of the first diffractive element 5b and the partial surface of the second diffractive element 5a. A light beam applied to the first diffractive element 5b is diffracted by its uneven surface and forms dipolar patterns 9b on the diffraction pattern surface 9 in the X direction, as shown in FIG. 9. A light beam applied to the second diffractive element 5a is diffracted by its uneven surface and forms dipolar patterns 9a on the diffraction pattern surface 9 in the Y direction, as shown in FIG. 9.

The zoom lens unit 3 (see FIG. 1) also acts to adjust the second irradiated region IR2j so that the amount of light beam applied to the first diffractive element 5b becomes equal to that of light beam applied to the second diffractive element 5a. With this operation, the diffraction patterns 9a and 9b are formed on the diffraction pattern surface 9 as quadrupole patterns in which the respective poles have equal intensity and which are symmetrical with respect to the optical axis PA.

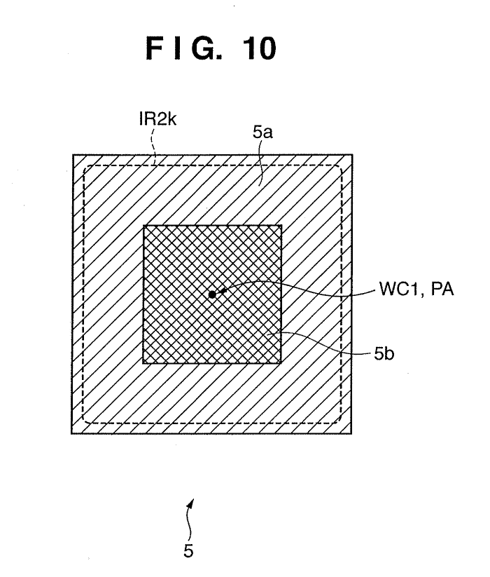

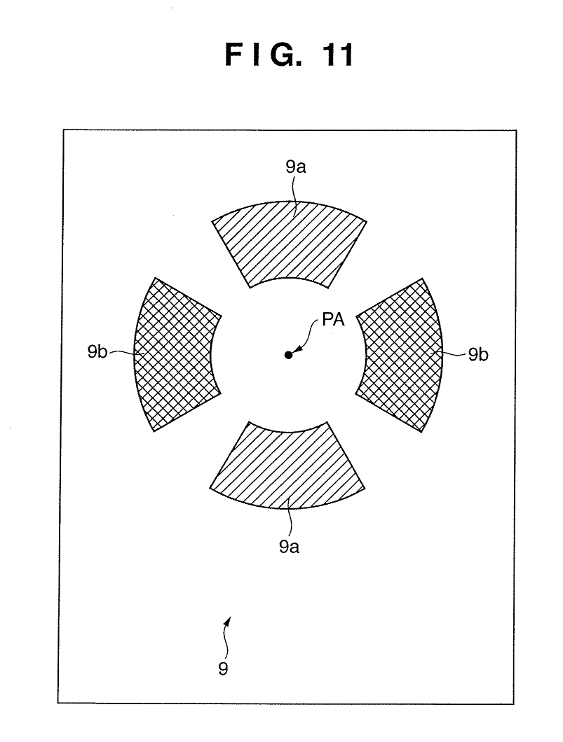

For example, as shown in FIG. 10, the zoom lens unit 3 (see FIG. 1) serving as the region adjusting unit adjusts a second irradiated region IR2k so that it covers the entire surface of the first diffractive element 5b and almost the entire surface of the second diffractive element 5a. A light beam applied to the first diffractive element 5b is diffracted by its uneven surface and forms dipolar patterns 9b on the diffraction pattern surface 9 in the X direction, as shown in FIG. 11. A light beam applied to the second diffractive element 5a is diffracted by its uneven surface and forms dipolar patterns 9a on the diffraction pattern surface 9 in the Y direction, as shown in FIG. 11.

The zoom lens unit 3 (see FIG. 1) also acts to adjust the second irradiated region IR2k so that the amount of light beam applied to the second diffractive element 5a becomes larger than that of light beam applied to the first diffractive element 5b. With this operation, the diffraction patterns 9a and 9b are formed on the diffraction pattern surface 9 as quadrupole patterns in which the dipoles in the Y direction have higher intensity than that of the dipoles in the X direction.

In this way, when the zoom lens unit 3 changes the area of the second irradiated region IR2 by zooming, it is possible to continuously adjust the shape and intensity distributions of effective light sources.

Meanwhile, instead of by zooming by means of the zoom lens unit 3, the area of the second irradiated region may be adjusted by partially shielding the light by means of a light-shielding member such as an iris stop or blade arranged as the region adjusting unit closer to the light source 1 than the diffractive optical element. Alternatively, the second irradiated region may be adjusted by switching microlenses having different irradiated angles in a microlens array arranged with a condenser lens as the region adjusting unit. The present invention is therefore not limited to the method of adjusting the irradiated region of a light beam which enter the diffractive optical element.

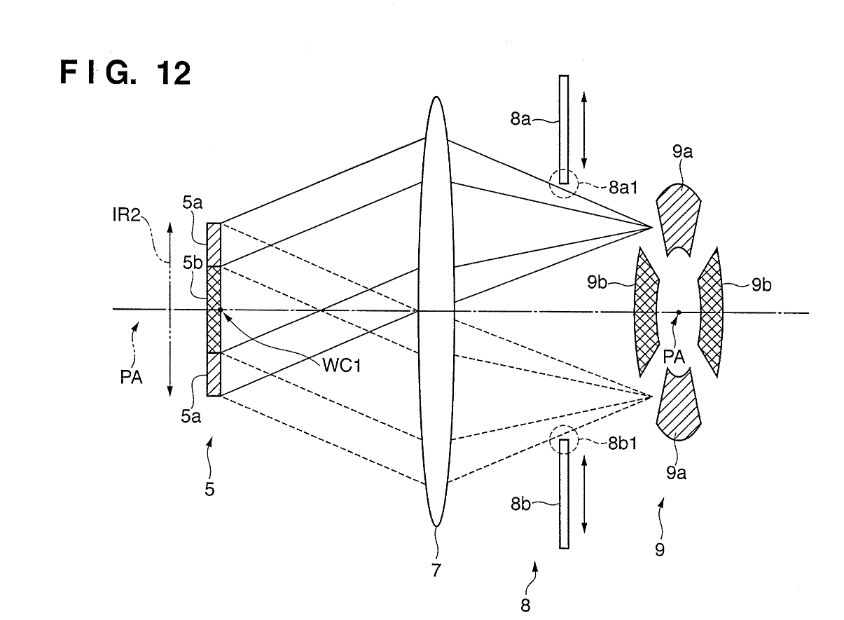

The detailed arrangement and operation of the light-shielding member will be explained with reference to FIG. 12. FIG. 12 shows an optical system from the diffractive optical element 5 to the diffraction pattern surface 9. For the sake of simplicity, FIG. 12 shows only light beams which emerge from the second diffractive element 5a.

As shown in FIG. 12, the condenser lens 7 is interposed between the diffractive optical element 5 and the diffraction pattern surface 9. The light-shielding member 8 is interposed between the condenser lens 7 and the diffraction pattern surface 9, that is, at a position defocused from the diffraction pattern surface 9. The light-shielding member 8 includes first and second blades 8a and 8b. The first and second blades 8a and 8b can be independently driven in the Y direction.

A light beam applied to the second diffractive element 5a is diffracted by its uneven surface as indicated by solid lines and broken lines, and guided to the condenser lens 7. The light beams indicated by the sold lines and broken lines are refracted by the condenser lens 7, are shielded or not shielded by the light-shielding member 8, and form dipolar patterns 9a on the diffraction pattern surface 9.

Assume that the light-shielding member 8 does not shield the light beams. Since the center (the intersection between the optical axis PA and the diffraction surface) of the second irradiated region IR2 coincides with the diffraction surface center of gravity WC1, the second diffractive element 5a has symmetry with respect to the optical axis PA. With this arrangement, the light beams indicated by the solid lines and those indicated by the broken lines travel to be symmetrical with respect to the optical axis PA. Accordingly, the directions (angular distribution) of the light beams which enter the upper and lower dipolar patterns 9a of the diffraction pattern surface 9 in FIG. 12 become symmetrical with respect to the optical axis PA.

Assume that the light-shielding member 8 shields the light beams. The light-shielding member 8 shields the light beams guided from the condenser lens 7 to the diffraction pattern surface 9 at a position defocused from the diffraction pattern surface 9. This makes it possible to guide the light beams indicated by the solid lines and broken lines to the diffraction pattern surface 9 without rapidly changing their intensities. It is therefore possible to adjust an effective light source distribution without rapidly changing the light intensity distribution.

When the light-shielding member 8 is controlled such that portions 8a1 and 8b1 of the first and second blades 8a and 8b, that are close to the optical axis PA are located to be symmetrical with respect to the optical axis PA, the shielded light beams indicated by the solid lines and broken lines are guided while being kept symmetrical about the optical axis PA. This makes it possible to suppress the directions (angular distribution) of the light beams which enter the dipolar patterns 9a in the X direction from becoming asymmetrical about the optical axis PA. It is therefore possible to suppress the telecentricity of a light beam with respect to the irradiation target surface from breaking and the CD uniformity from decreasing.

As has been described above, according to the first embodiment, it is possible to adjust an effective light source distribution without adversely affecting the imaging performance such as telecentricity and CD uniformity. This makes it possible to increase the degree of freedom in forming an effective light source and execute exposure under an optimal illumination condition to result in an improvement in the productivity of a semiconductor device.

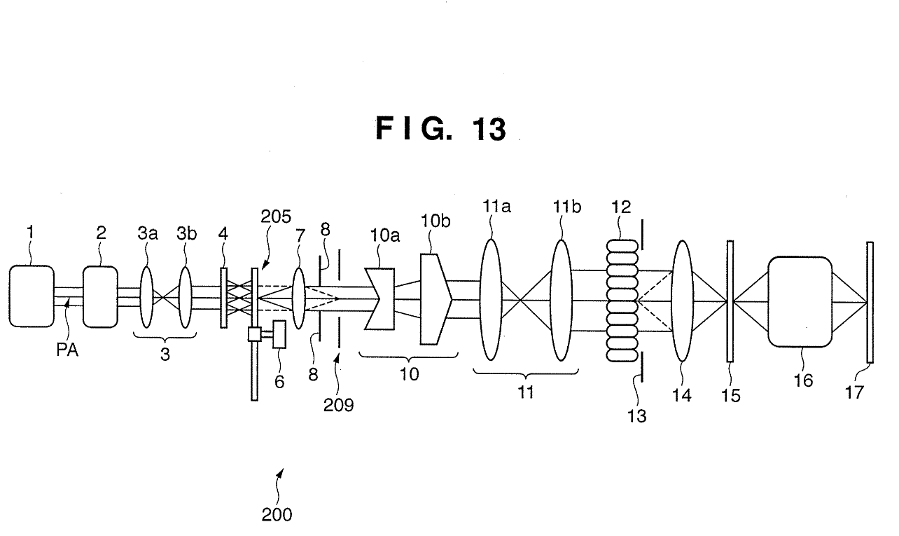

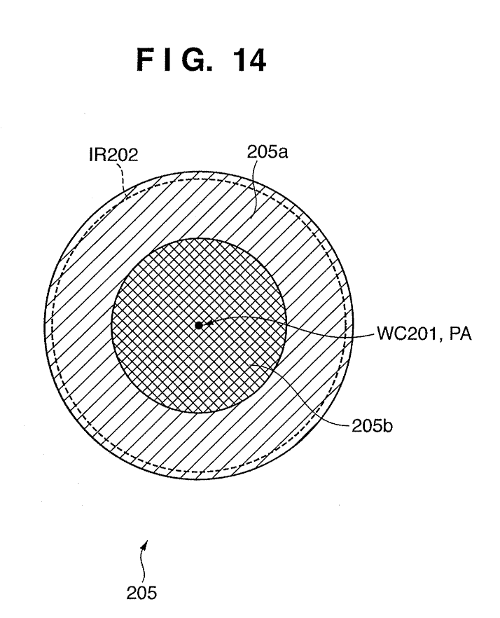

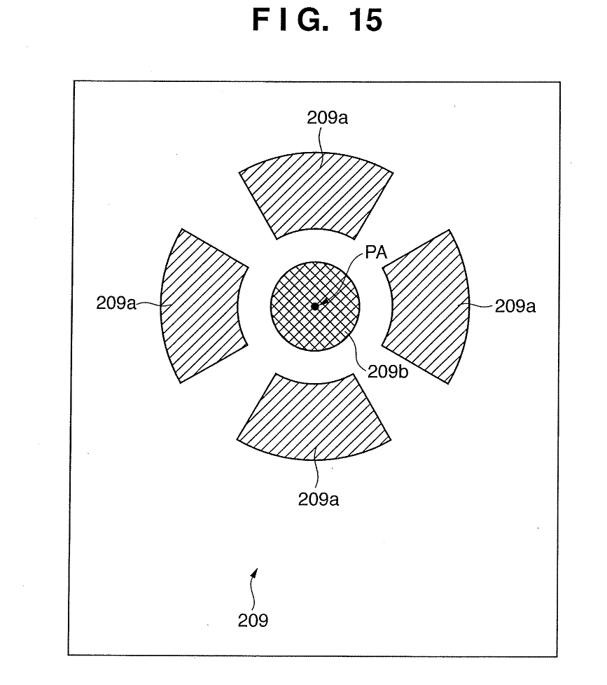

An exposure apparatus according to the second embodiment of the present invention will be explained with reference to FIGS. 13 to 15. Parts different from those in the first embodiment will be mainly described, and a description of the same parts will not be repeated. FIG. 13 shows the arrangement of the exposure apparatus according to the second embodiment. FIG. 14 shows the arrangement of a diffractive optical element according to the second embodiment. FIG. 15 shows diffraction patterns formed on a diffraction pattern surface.

As shown in FIG. 13, although the basic arrangement of an exposure apparatus 200 is the same as that in the first embodiment, the second embodiment is different from the first embodiment in that a diffractive optical element 205 substitutes for the diffractive optical element 5.

As shown in FIG. 14, the diffractive optical element 205 comprises first and second diffractive elements 205b and 205a.

The first diffractive element 205b is indicated by a cross-hatched portion and formed into an almost circular shape having point symmetry about a diffraction surface center of gravity WC201 of the diffractive optical element 205.

The second diffractive element 205a is indicated by a hatched portion and surrounds the first diffractive element 205b. The second diffractive element 205a is formed into an almost hollow circular shape having point symmetry with respect to the diffraction surface center of gravity WC201 of the diffractive optical element 205.

Assume, for example, that a second irradiated region IR202 covers the entire surface of the diffractive optical element 205, that is, the entire surfaces of the first and second diffractive elements 205b and 205a. A light beam applied to the first diffractive element 205b is diffracted by its uneven surface and forms a circular pattern 209b on a diffraction pattern surface 209 (see FIG. 13), as shown in FIG. 15. A light beam applied to the second diffractive element 205a is diffracted by its uneven surface and forms quadrupolar patterns 209a on the diffraction pattern surface 209 in the X and Y directions, as shown in FIG. 15. The circular pattern 209b and quadrupolar patterns 209a have their own symmetry centers. All these symmetry centers lie near an optical axis PA. That a certain pattern has a symmetry center means it has an infinite number of symmetry axes. In other words, from the viewpoint of the group theory, that a certain pattern has a symmetry center means it has a better symmetry than when it has a finite number of symmetry axes. That is, the circular pattern 209b and quadrupolar patterns 209a have a better symmetry than the diffraction patterns in the first embodiment. The uneven shapes do not need to have point symmetry.

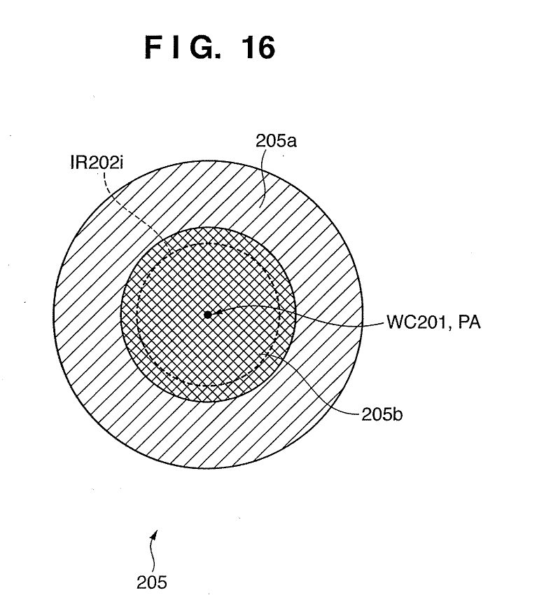

As shown in FIGS. 16 to 19, effects of zooming by a zoom lens unit 3 are different from those in the first embodiment in the following points.

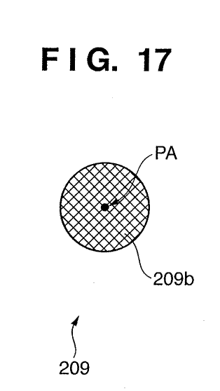

For example, as shown in FIG. 16, the zoom lens unit 3 (see FIG. 13) adjusts a second irradiated region IR202i so that it covers only the first diffractive element 205b. A light beam applied to the first diffractive element 205b is diffracted by its uneven surface and forms a circular pattern 209b (see FIG. 17) on the diffraction pattern surface 209. On the other hand, the second diffractive element 205a receives no light beam and hence forms no quadrupolar patterns 209a (see FIG. 15) on the diffraction pattern surface 209.

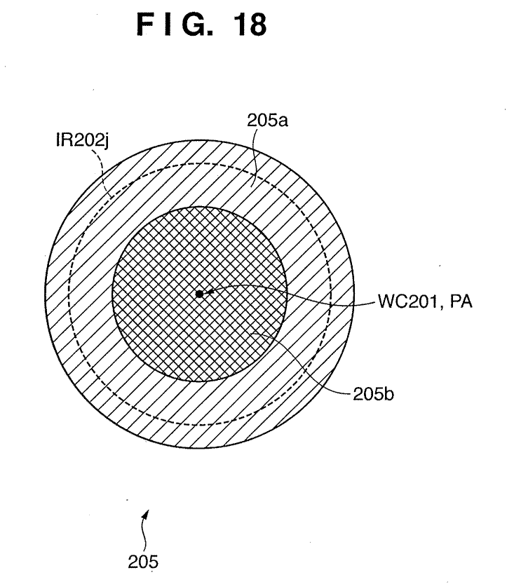

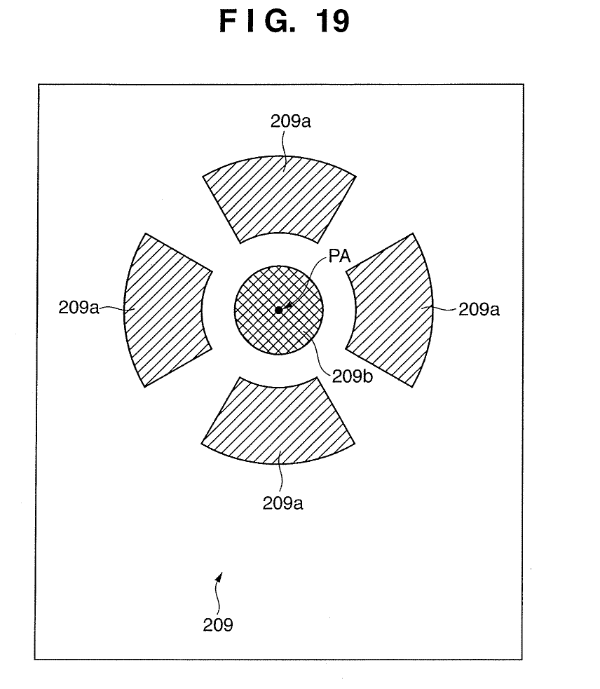

For example, as shown in FIG. 18, the zoom lens unit 3 (see FIG. 13) adjusts a second irradiated region IR202j so that it covers the entire surface of the first diffractive element 205b and the partial surface of the second diffractive element 205a. A light beam applied to the first diffractive element 205b is diffracted by its uneven surface and forms a circular pattern 209b (see FIG. 19) on the diffraction pattern surface 209. A light beam applied to the second diffractive element 205a is diffracted by its uneven surface and forms quadrupolar patterns 209a (see FIG. 19) on the diffraction pattern surface 209.

In this way, when the zoom lens unit 3 changes the area of the second irradiated region IR202 with a better symmetry than in the first embodiment, it is possible to adjust an effective light source distribution. This makes it possible to further suppress the telecentricity of a light beam with respect to the irradiation target surface from breaking and the CD uniformity from decreasing. It is therefore possible to minimize deterioration in imaging performance at a higher level.

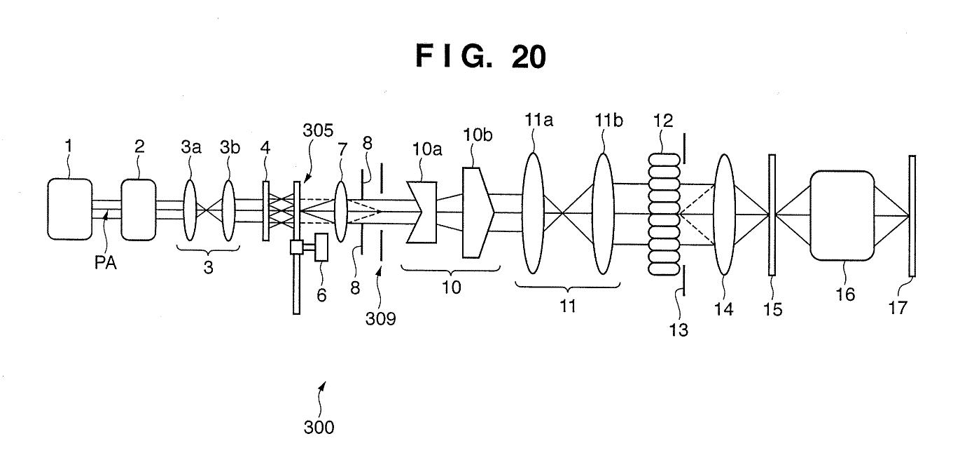

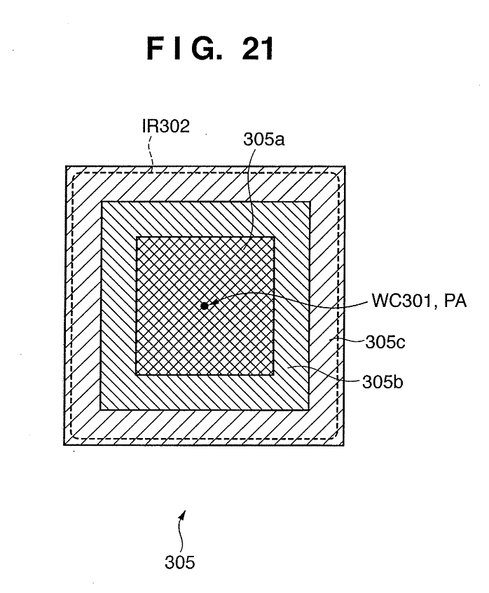

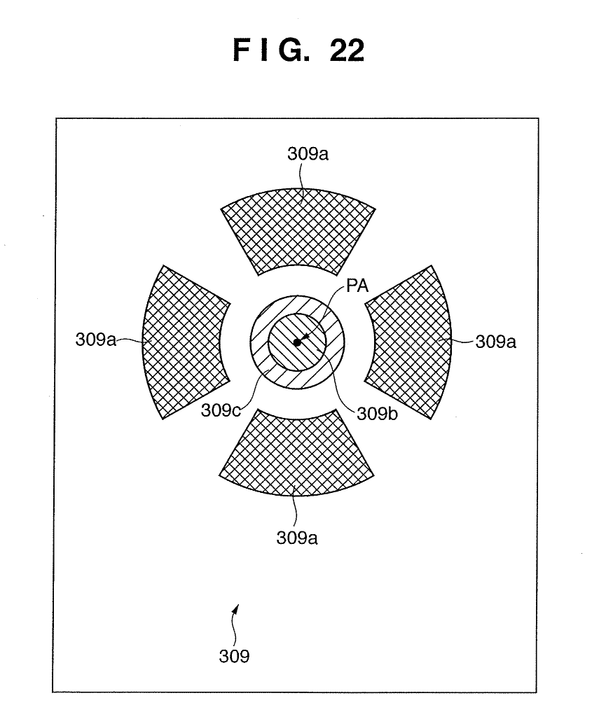

An exposure apparatus according to the third embodiment of the present invention will be explained with reference to FIGS. 20 to 22. Parts different from those in the first embodiment will be mainly described, and a description of the same parts will not be repeated. FIG. 20 shows the arrangement of the exposure apparatus according to the third embodiment. FIG. 21 shows the arrangement of a diffractive optical element according to the third embodiment. FIG. 22 shows diffraction patterns formed on a diffraction pattern surface.

As shown in FIG. 20, although the basic arrangement of an exposure apparatus 300 is the same as that in the first embodiment, the third embodiment is different from the first embodiment in that a diffractive optical element 305 substitutes for the diffractive optical element 5. As shown in FIG. 21, the diffractive optical element 305 comprises first, second, and third diffractive elements 305a, 305b, and 305c.

The first diffractive element 305a is indicated by a cross-hatched portion and formed into an almost square shape having point symmetry (more specifically, 4-fold rotational symmetry) with respect to a diffraction surface center of gravity WC301 of the diffractive optical element 305.

The second diffractive element 305b is indicated by a densely hatched portion and surrounds the first diffractive element 305a. The second diffractive element 305b is formed into an almost hollow square shape having point symmetry (more specifically, 4-fold rotational symmetry) with respect to the diffraction surface center of gravity WC301 of the diffractive optical element 305.

The third diffractive element 305c is indicated by a hatched portion and surrounds the first and second diffractive elements 305a and 305b. The third diffractive element 305c is formed into an almost hollow square shape having point symmetry (more specifically, 4-fold rotational symmetry) with respect to the diffraction surface center of gravity WC301 of the diffractive optical element 305.

Assume, for example, that a second irradiated region IR302 covers the entire surface of the diffractive optical element 305, that is, the entire surfaces of the first, second, and third diffractive elements 305a, 305b, and 305c, as shown in FIG. 21. A light beam applied to the first diffractive element 305a is diffracted by its uneven surface and forms quadrupolar patterns 309a on a diffraction pattern surface 309 (see FIG. 20), as shown in FIG. 22. A light beam applied to the second diffractive element 305b is diffracted by its uneven surface and forms a circular pattern 309b (see FIG. 22) on the diffraction pattern surface 309. A light beam applied to the third diffractive element 305c is diffracted by its uneven surface and forms a ring-like pattern 309c (see FIG. 22) on the diffraction pattern surface 309. The quadrupolar patterns 309a, circular pattern 309b, and ring-like pattern 309c have their own symmetry centers. All these symmetry centers lie near an optical axis PA. The uneven shapes do not need to have point symmetry.

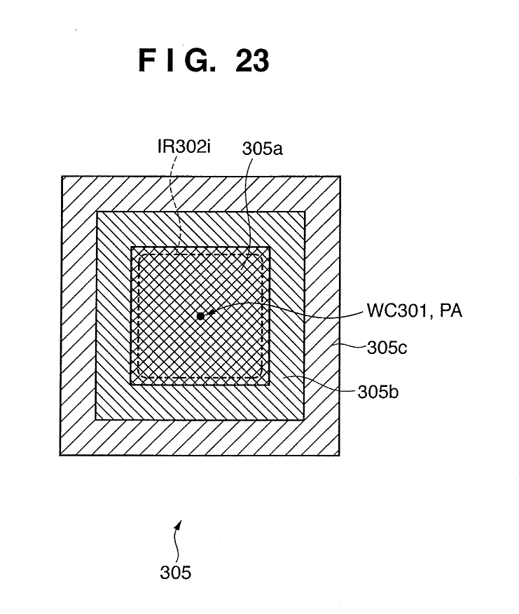

As shown in FIGS. 23 to 28, effects of zooming by a zoom lens unit 3 are different from those in the first embodiment in the following points.

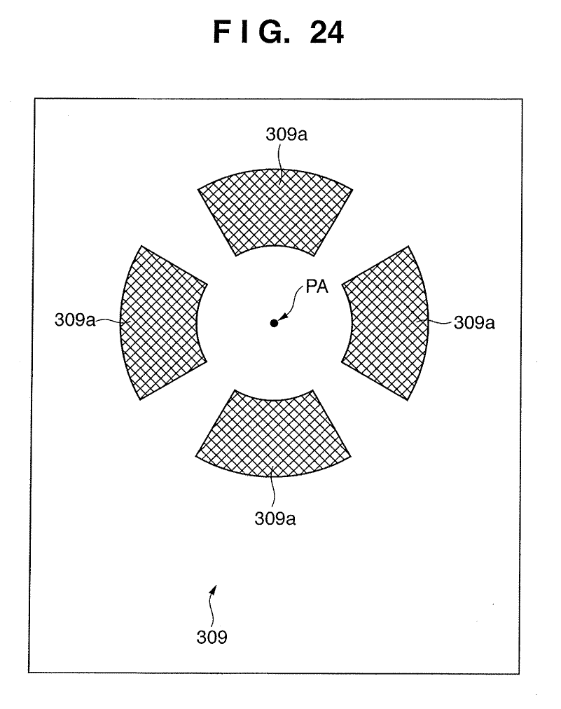

For example, as shown in FIG. 23, the zoom lens unit 3 (see FIG. 20) adjusts a second irradiated region IR302i so that it covers only the first diffractive element 305a. A light beam applied to the first diffractive element 305a is diffracted by its uneven surface and forms quadrupolar patterns 309a (see FIG. 24) on the diffraction pattern surface 309. On the other hand, the second and third diffractive elements 305b and 305c receive no light beams and hence form neither a circular pattern 309b nor a ring-like pattern 309c (see FIG. 22) on the diffraction pattern surface 309.

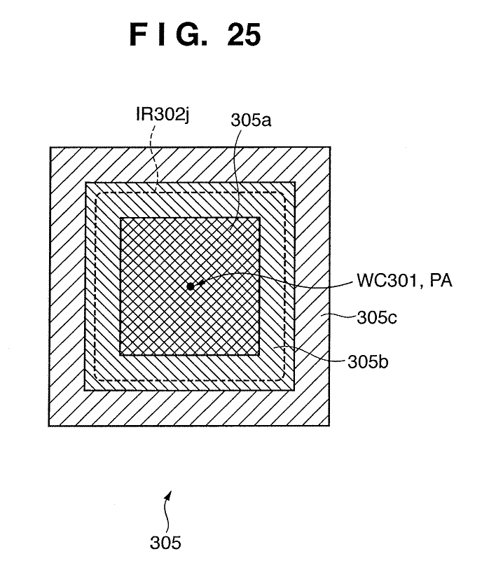

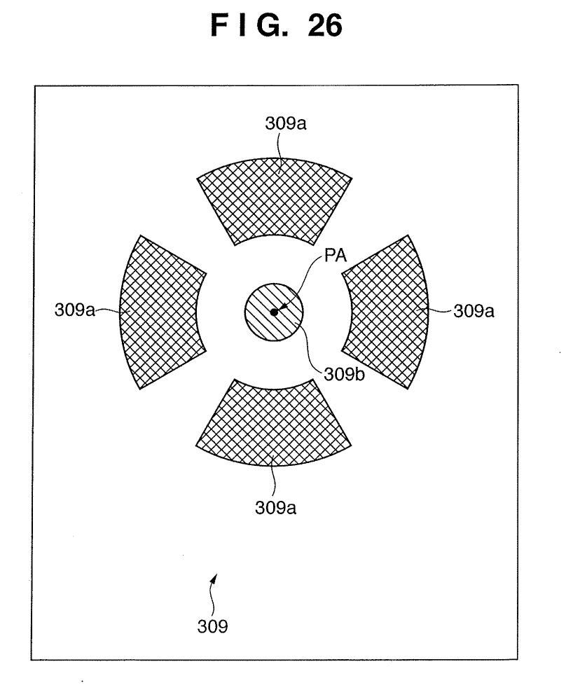

For example, as shown in FIG. 25, the zoom lens unit 3 (see FIG. 20) adjusts a second irradiated region IR302j so that it covers the entire surfaces of the first and second diffractive elements 305a and 305b. A light beam applied to the first diffractive element 305a is diffracted by its uneven surface and forms quadrupolar patterns 309a (see FIG. 26) on the diffraction pattern surface 309. A light beam applied to the second diffractive element 305b is diffracted by its uneven surface and forms a circular pattern 309b on the diffraction pattern surface 309, as shown in FIG. 26. On the other hand, the third diffractive element 305c receives no light beam and hence forms no ring-like pattern 309c (see FIG. 22) on the diffraction pattern surface 309.

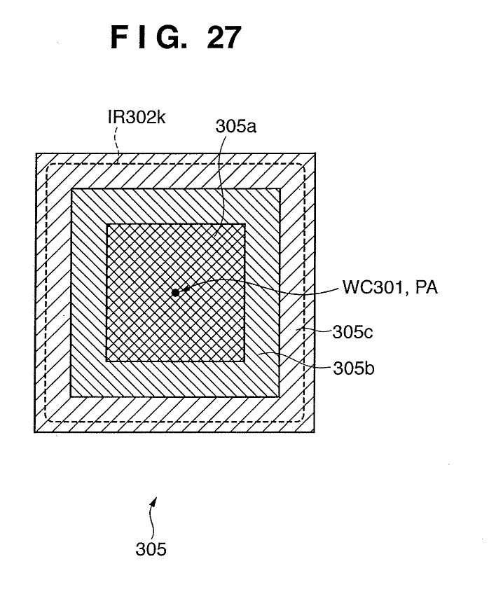

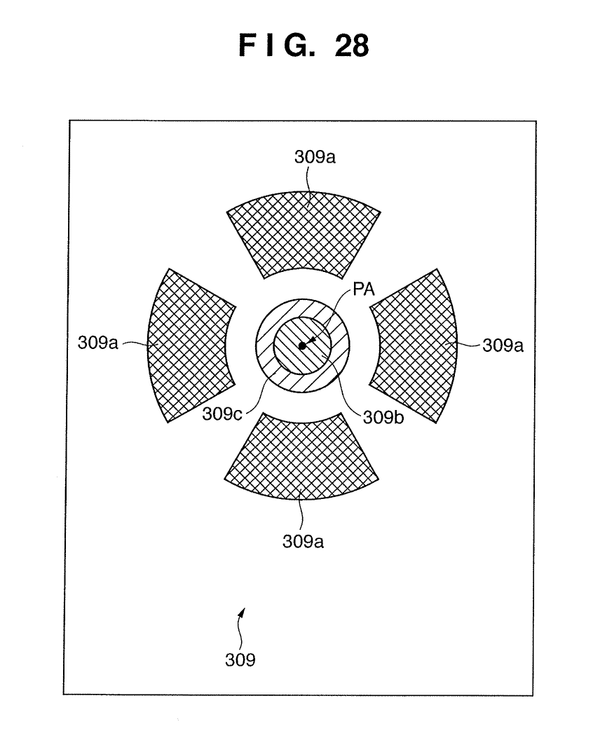

For example, as shown in FIG. 27, the zoom lens unit 3 (see FIG. 20) adjusts a second irradiated region IR302k so that it covers the entire surfaces of the first, second, and third diffractive elements 305a, 305b, and 305c. A light beam applied to the first diffractive element 305a is diffracted by its uneven surface and forms quadrupolar patterns 309a (see FIG. 28) on the diffraction pattern surface 309. A light beam applied to the second diffractive element 305b is diffracted by its uneven surface and forms a circular pattern 309b (see FIG. 28) on the diffraction pattern surface 309. A light beam applied to the third diffractive element 305c is diffracted by its uneven surface and forms a ring-like pattern 309c (see FIG. 28) on the diffraction pattern surface 309.

In this way, when the zoom lens unit 3 changes the area of the second irradiated region IR202 with good symmetry, it is possible to adjust an effective light source distribution with good symmetry. This makes it possible to suppress the telecentricity of a light beam with respect to the irradiation target surface from breaking and the CD uniformity from decreasing. It is therefore possible to minimize deterioration in imaging performance.

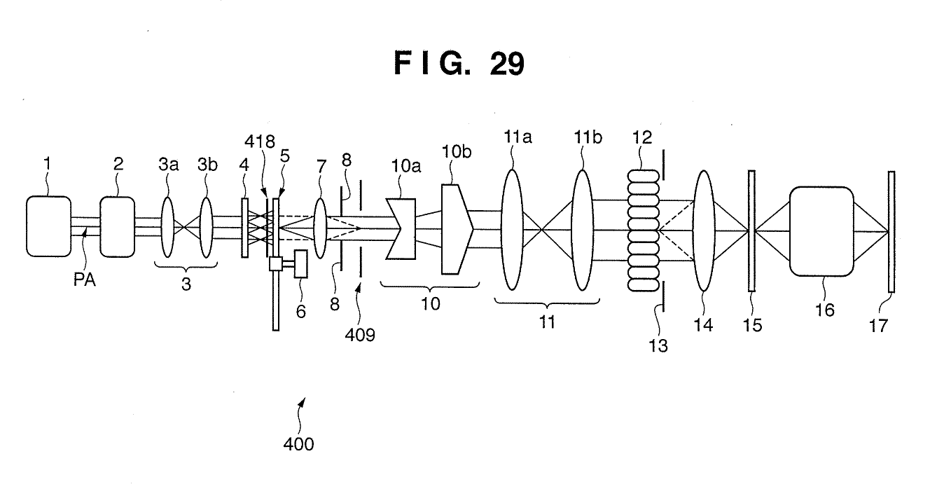

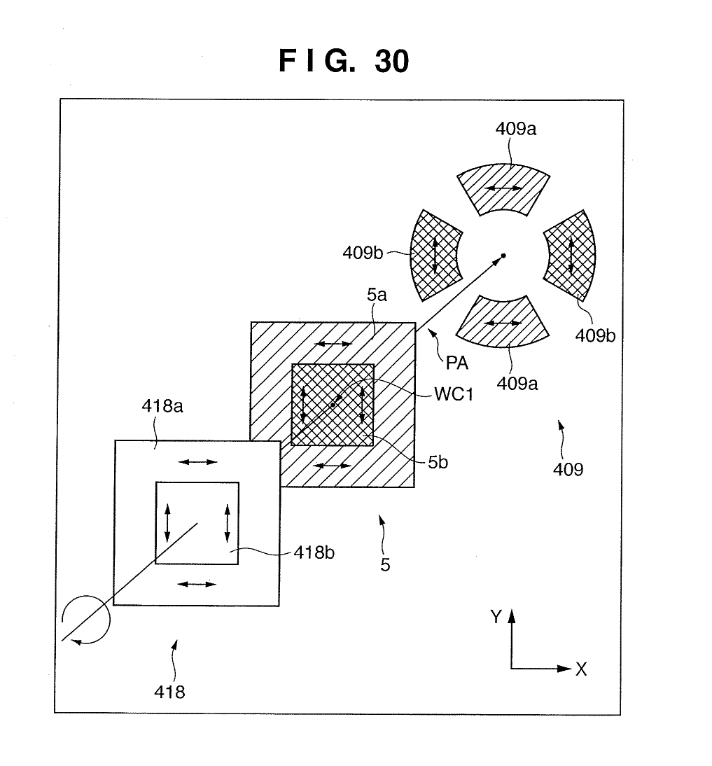

An exposure apparatus according to the fourth embodiment of the present invention will be explained with reference to FIGS. 29 and 30. Parts different from those in the first embodiment will be mainly described, and a description of the same parts will not be repeated. FIG. 29 shows the arrangement of the exposure apparatus according to the fourth embodiment. FIG. 30 shows the relationship between the optical axis and the polarization direction.

As shown in FIG. 29, although the basic arrangement of an exposure apparatus 400 is the same as that in the first embodiment, the fourth embodiment is different from the first embodiment in that the exposure apparatus 400 further comprises a polarization adjusting element 418.

As shown in FIG. 30, the polarization adjusting element 418 is arranged closer to a light source 1 than a diffractive optical element 5. Although the polarization adjusting element 418 is arranged closer to the light source 1 than the diffractive optical element 5 in the fourth embodiment, this arrangement order may be reversed. The polarization adjusting element 418 may be integrated into the diffractive optical element 5 via SWS (SubWavelength Structure). The polarization adjusting element 418 comprises first and second polarizing elements 418b and 418a. The first and second polarizing elements 418b and 418a respectively act as a λ/4 phase plate having two different polarization directions. For example, if the both elements 418b, 418a receive the same circularly polarized light, the both elements 418b, 418a emit different polarized light having different polarization directions.

The first polarizing element 418b has almost the same area and shape and almost the same direction with respect to an optical axis PA as those of a first diffractive element 5b of the diffractive optical element 5. Likewise, the second polarizing element 418a has almost the same area and shape and almost the same direction with respect to the optical axis PA as those of a second diffractive element 5a of the diffractive optical element 5. Hence, the polarization adjusting element 418 has the same symmetry as that of the diffractive optical element 5.

For the sake of easy understanding, the polarization adjusting element 418 is spaced apart from the diffractive optical element 5 in FIG. 30. In practice, however, they are in tight contact with each other.

As shown in FIG. 30, when a circularly polarized light enters the polarization adjusting element 418, a light component which has passed through the first polarizing element 418b is converted into a linearly polarized light component in the Y direction, while a light component which has passed through the second polarizing element 418a is converted into a linearly polarized light component in the X direction. The light component linearly polarized in the Y direction enters the first diffractive element 5b of the diffractive optical element 5, while the light component linearly polarized in the X direction enters the second diffractive element 5a of the diffractive optical element 5.

The actions of the polarization adjusting element 418 and diffractive optical element 5 form, on a diffraction pattern surface 409, Y-polarized dipolar patterns 409b that polarize in the X direction, and X-polarized dipolar patterns 409a that polarize in the Y direction. A combination of the four dipolar patterns 409a and 409b forms quadrupolar patterns with tangential polarization. Quadrupole illumination with tangential polarization enhances the resolution and hence is suitable for micropattern exposure. It should be noted that λ/2 phase plate can be used in place of the second polarizing element 418a acting as the λ/4 phase plate (wavelength plate) when the light which enters the polarization adjusting element 418 is linearly polarized in the Y direction. In this case, an optical element which does not change polarization directions such as a glass plate can be arranged in place of the first polarizing element 418b. With this arrangement tangential polarization can also be achieved.

As is obvious from the above-described embodiments, the present invention is useful for adjusting an effective light source distribution while minimizing deterioration in imaging performance. This makes it possible to expose a semiconductor device under a preferable illumination condition.

Meanwhile, in the above-described embodiments, of diffractive elements formed on a diffraction optical device, even the outmost diffractive element farthest from the diffraction surface center of gravity has point symmetry. However, this outmost diffractive element need not wholly satisfy point symmetry as long as it satisfies point symmetry in an illumination region on the diffractive optical element.

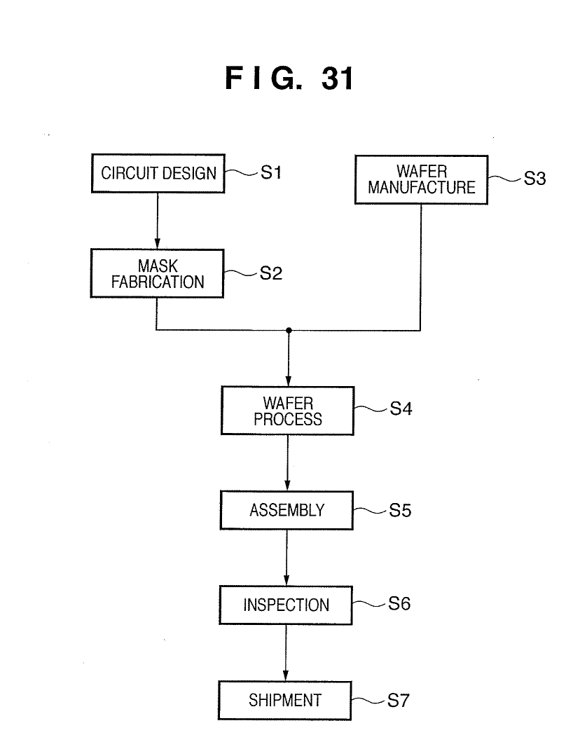

A semiconductor device manufacturing process using an exposure apparatus according to the present invention will be explained next. FIG. 31 is a flowchart illustrating the sequence of the overall semiconductor device manufacturing process. In step S1 (circuit design), the circuit of a semiconductor device is designed. In step S2 (mask fabrication), a mask (also called a mask or reticle) is fabricated based on the designed circuit pattern. In step S3 (wafer manufacture), a wafer (also called a substrate) is manufactured using a material such as silicon. In step S4 (wafer process) called a pre-process, the above-described exposure apparatus forms an actual circuit on the wafer by lithography using the mask and wafer. In step S5 (assembly) called a post-process, a semiconductor chip is formed using the wafer manufactured in step S4. This step includes an assembly step (dicing and bonding) and packaging step (chip encapsulation). In step S6 (inspection), the semiconductor device manufactured in step S5 undergoes inspections such as an operation confirmation test and durability test. After these steps, the semiconductor device is completed and shipped in step S7.

The wafer process in step S4 includes: an oxidation step of oxidizing the wafer surface; a CVD step of forming an insulating film on the wafer surface; an electrode formation step of forming an electrode on the wafer by vapor deposition; an ion implantation step of implanting ions in the wafer; a resist processing step of applying a photosensitive agent to the wafer; an exposure step of exposing, using the above-described exposure apparatus, the wafer having undergone the resist processing step to light via the mask pattern to form a latent pattern on the resist; a development step of developing the latent pattern formed on the wafer exposed in the exposure step; an etching step of etching portions other than the latent pattern developed in the development step; and a resist removal step of removing any unnecessary resist remaining after etching. These steps are repeated to form multiple circuit patterns on the wafer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2006-243392, filed Sep. 7, 2006, and No. 2007-217244, filed Aug. 23, 2007, which are hereby incorporated by reference herein in their entirety.

What is claimed is:

1. A diffractive optical element used in an illumination optical system of an exposure apparatus which exposes a substrate, and used for forming the intensity distribution of light at a pupil plane of the illumination optical system, the diffractive optical element comprising:
a first diffractive element and a second diffractive element which have different diffraction actions from each other,
wherein each of the first diffractive element and the second diffractive element has point symmetry in a irradiated region where light is irradiated and common center of the point symmetry.

2. The diffractive optical element according to claim 1, wherein
the second diffractive element is formed to surround the first diffractive element.

3. The diffractive optical element according to claim 1,
the diffractive optical element is a computer generated hologram.

4. The diffractive optical element according to claim 1,
The diffractive optical element has subwavelength structure that adjusts polarization state of light.

5. An exposure apparatus which illuminates a mask by a illumination optical system exposes a substrate by projecting a pattern of the mask onto the substrate via a projection optical system, the exposure apparatus comprising:
a diffractive optical element including a first diffractive element and a second diffractive element which have different diffraction actions from each other, the diffractive optical element forming the intensity distribution of light at a pupil plane of the illumination optical system,
wherein each of the first diffractive element and the second diffractive element has point symmetry in a irradiated region where light is irradiated and common center of the point symmetry.

6. The exposure apparatus according to claim 5, the exposure apparatus further comprising:
a region adjusting unit which adjusts the irradiated region of the diffractive optical element.

7. The exposure apparatus according to claim 6, wherein
the region adjusting unit changes an area of the irradiated region.

8. The exposure apparatus according to claim 5, the exposure apparatus further comprising:
a polarization adjusting element which adjusts polarization state of light.

9. The exposure apparatus according to claim 8, wherein
the polarization adjusting element including
a first polarizing element having a shape corresponding to the first diffractive element, and
a second polarizing element having a shape corresponding to the second diffractive element.

10. The exposure apparatus according to claim 8, wherein
the diffractive optical element and the polarization adjusting element are integrally formed.

11. A device manufacturing method comprising the steps of:
forming a latent pattern on a substrate using an exposure apparatus defined in claim 5; and
developing the latent pattern.
